(19) United States
(12) Patent Application Publication
(10) Pub. No.: US 2026/0353383 A1
(43) Pub. Date: Nov. 5, 2026

(54) LOGICAL CHANNEL SCHEDULING METHOD, APPARATUS, COMMUNICATION DEVICE, AND STORAGE MEDIUM

(71) Applicant: BEIJING XIAOMI MOBILE SOFTWARE CO., LTD., Beijing (CN)

(72) Inventors: Yanhua LI, Beijing (CN); Yumin WU, Beijing (CN)

(73) Assignee: BEIJING XIAOMI MOBILE SOFTWARE CO., LTD., Beijing (CN)

(21) Appl. No.: 19/102,008

(22) PCT Filed: Aug. 9, 2022
(86) PCT No.: PCT/CN2022/111287

§ 371 Date: Feb. 7, 2025

(51) Int. Cl. H04W 72/1263; H04W 28/02; H04W 72/56

(52) U.S. Cl. CPC H04W 72/1263; H04W 28/0273; H04W 72/56

(57) ABSTRACT

Provided in the embodiments of the present disclosure is a logical channel scheduling method. The method is executed by a base station, and the method comprises: sending to a terminal first indication information, the first indication information being used for indicating a predetermined association relationship present between at least two logical channels. The base station sends to the terminal the first indication information which indicates the predetermined association relationship present between the at least two logical channels. The terminal, when receiving the first indication information, on the basis of the predetermined association relationship indicated by the first indication information, determines whether at least one logical channel uses authorization of a network.

### CROSS-REFERENCE TO RELATED APPLICATION

The application is a U.S. National Stage of International Application No. PCT/CN2022/111287 filed on Aug. 9, 2022, the entire content of which is incorporated herein by reference for all purposes.

### TECHNICAL FIELD

The present disclosure relates to, but is not limited to, the technical field of wireless communication, and in particular, to a method and apparatus for scheduling a logical channel, a communication device and a storage medium.

### BACKGROUND

In a service scenario, data consists of a plurality of Quality of Service (QoS) flows. Usually, different QoS flows are assigned to handle services with different priority levels, that is, different QoS flows are configured with different information, such as different logical channel priority levels, etc. Different QoS flows need to be synchronized, that is, it is not allowed that transmission of one QoS flow is completed while another data flow has no transmission opportunity. If the two QoS flows cannot arrive at the application layer at the same time, the arrived data packet has to be discarded. Therefore, in the related art, the problem of scheduling logical channels needs to be considered.

### SUMMARY

The embodiments of the present disclosure disclose a method and an apparatus for scheduling a logical channel, a communication device and a storage medium.

According to a first aspect of the embodiments of the present disclosure, a method for scheduling a logical channel is provided, where the method is performed by a base station, and the method includes:

sending first indication information to a terminal;

where the first indication information is used to indicate: a predetermined association relationship existing between at least two logical channels.

According to a second aspect of the embodiments of the present disclosure, a method for scheduling a logical channel is provided, where the method is performed by a terminal, and the method includes:

receiving first indication information sent by a base station;

where the first indication information is used to indicate: a predetermined association relationship existing between at least two logical channels.

According to a third aspect of the embodiments of the present disclosure, an apparatus for scheduling a logical channel is provided, where the apparatus includes:

a sending module, configured to send first indication information to a terminal;

where the first indication information is used to indicate: a predetermined association relationship existing between at least two logical channels.

According to a fourth aspect of the embodiments of the present disclosure, an apparatus for scheduling a logical channel is provided, where the apparatus includes:

a receiving module, configured to receive first indication information sent by a base station;

where the first indication information is used to indicate: a predetermined association relationship existing between at least two logical channels.

According to a fifth aspect of the embodiments of the present disclosure, a system for scheduling a logical channel is provided, where the system includes a terminal and a base station, the terminal executes any of the methods executed by the terminal in the embodiments of the present disclosure, and the base station executes any of the methods executed by the base station in the embodiments of the present disclosure.

According to a sixth aspect of the embodiments of the present disclosure, a communication device is provided, and the communication device includes:

a processor; and

a memory for storing instructions executable by the processor;

where the processor is configured to implement the method described in any embodiment of the present disclosure when running the executable instructions.

According to a seventh aspect of an embodiment of the present disclosure, a computer storage medium is provided, where the computer storage medium stores a computer executable program, and the executable program implements the method described in any embodiment of the present disclosure when being executed by the processor.

### BRIEF DESCRIPTION OF THE DRAWINGS

FIG. 1 is a schematic structural diagram of a wireless communication system shown according to one or more exemplary embodiments of the present disclosure.

FIG. 2 is a schematic flow chart of a method for scheduling a logical channel shown according to one or more exemplary embodiments of the present disclosure.

FIG. 3 is a schematic flow chart of a method for scheduling a logical channel shown according to one or more exemplary embodiments of the present disclosure.

FIG. 4 is a schematic flow chart of a method for scheduling a logical channel shown according to one or more exemplary embodiments of the present disclosure.

FIG. 5 is a schematic flow chart of a method for scheduling a logical channel shown according to one or more exemplary embodiments of the present disclosure.

FIG. 6 is a schematic flow chart of a method for scheduling a logical channel shown according to one or more exemplary embodiments of the present disclosure.

FIG. 7 is a schematic flow chart of a method for scheduling a logical channel shown according to one or more exemplary embodiments of the present disclosure.

FIG. 8 is a schematic flow chart of a method for scheduling a logical channel shown according to one or more exemplary embodiments of the present disclosure.

FIG. 9 is a schematic structural diagram of an apparatus for scheduling a logical channel shown according to one or more exemplary embodiments of the present disclosure.

FIG. 10 is a schematic structural diagram of an apparatus for scheduling a logical channel shown according to one or more exemplary embodiments of the present disclosure.

FIG. 11 is a schematic structural diagram of a terminal shown according to one or more exemplary embodiments of the present disclosure.

FIG. 12 is a block diagram of a base station shown according to one or more exemplary embodiments of the present disclosure.

### DETAILED DESCRIPTION

Exemplary embodiments will be described in detail herein, examples of which are represented in the accompanying drawings. When the following description relates to the drawings, the same numerals in different accompanying drawings represent the same or similar elements unless otherwise indicated. The implementations described in the following exemplary embodiments do not represent all implementations consistent with the embodiments of the present disclosure. To the contrary, they are merely examples of apparatuses and methods that are consistent with some aspects of the embodiments of the present disclosure.

Terms used in the embodiments of the present disclosure are used solely for the purpose of describing certain embodiments and are not intended to limit the embodiments of the present disclosure. The singular forms of “a/an” and “the” used in the present disclosure are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the embodiments of the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when . . . ” or “in the case . . . ” or “in response to determination”.

For the purpose of brevity and ease of understanding, the terms “greater than” or “less than” are used herein to characterize size relationships. However, those skilled in the art can understand that the term “greater than” also covers the meaning of “greater than or equal to”, and “less than” also covers the meaning of “less than or equal to”.

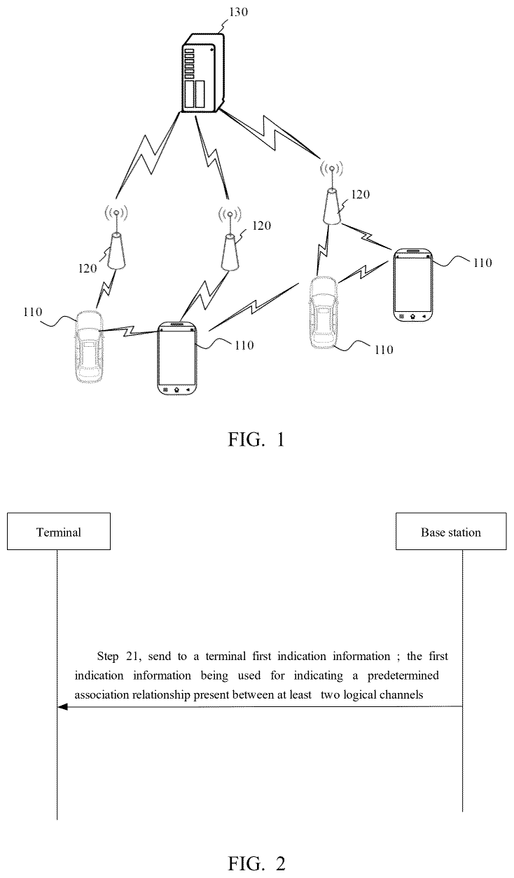

Referring to FIG. 1, a schematic structural diagram of a wireless communication system provided by an embodiment of the present disclosure is illustrated. As shown in FIG. 1, the wireless communication system is a communication system based on mobile communication technology, and the wireless communication system may include: several user equipments 110 and several base stations 120.

The user equipment 110 may refer to a device that provides voice and/or data connectivity to a user. The user equipment 110 may communicate with one or more core networks via a radio access network (RAN). The user equipment 110 may be an IoT terminal, such as a sensor device, a mobile phone, and a computer with an IoT user equipment, for example, it may be a fixed, portable, pocket-sized, handheld, computer-built-in, or vehicle-mounted apparatus, e.g., a station (STA), a subscriber unit, a subscriber station, a mobile station, a mobile, a remote station, an access point, a remote user equipment (remote terminal), an access UE (access terminal), a user terminal, a user agent, a user device or a user equipment. Alternatively, the user equipment 110 may be a device of an unmanned aerial vehicle. Alternatively, the user equipment 110 may be a vehicle-mounted device, for example, it may be a trip computer with a wireless communication function, or a wireless communication device externally connected to a trip computer. Alternatively, the user equipment 110 may be a roadside device, for example, a street lamp, a signal lamp, or other roadside device with a wireless communication function.

The base station 120 may be a network side device in a wireless communication system. The wireless communication system may be the 4th generation mobile communication technology (4G) system, also known as a long term evolution (LTE) system; or, the wireless communication system may be a 5G system, also known as a new radio (NR) system or a 5G NR system. Alternatively, the wireless communication system may be a next generation system after the 5G system. The access network in the 5G system may be referred to as a new generation-radio access network (NG-RAN).

The base station 120 may be an evolved base station (eNB) used in a 4G system. Alternatively, the base station 120 may also be a base station (gNB) using a centralized and distributed architecture in a 5G system. When the base station 120 uses the centralized and distributed architecture, it usually includes a central unit (CU) and at least two distributed units (DU). The central unit is provided with protocol stacks of a packet data convergence protocol (PDCP) layer, a radio link layer control protocol (Radio Link Control, RLC) layer, and a media access control (MAC) layer; and the distributed unit is provided with a protocol stack of a physical (PHY) layer. The specific implementation manner of the base station 120 is not limited by the embodiments of the present disclosure.

A wireless connection may be established between the base station 120 and the user equipment 110 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard after 5G.

In some embodiments, an end to end (E2E) connection may also be established between the user equipments 110, for example, scenarios like vehicle to vehicle (V2V) communication, vehicle to infrastructure (V2I) communication, and vehicle to pedestrian (V2P) communication in vehicle to everything (V2X) communication.

Here, the above-mentioned user equipment may be considered as the terminal device of the following embodiments.

In some embodiments, the wireless communication system may further include a network management device 130.

Several base stations 120 are respectively connected to the network management device 130. The network management device 130 may be an access and mobility management function (AMF), a session management function (SMF), a user plane function (UPF), a policy control function (PCF), a network repository function (NRF), etc. The embodiments of the present disclosure do not limit the implementation form of the network management device 130.

In order to facilitate the understanding of those skilled in the art, the embodiments of the present disclosure list a plurality of implementation manners to clearly illustrate the technical solutions of the embodiments of the present disclosure. The plurality of embodiments provided by the embodiments of the present disclosure may be performed individually, or in combination with the methods of other embodiments of the embodiments of the present disclosure, or in combination with some other methods in the related art when performed individually or in combination; and the embodiments of the present disclosure are not limited thereto.

In order to better understand the technical solutions described in any embodiment of the present disclosure, the application scenarios in the related art are first described as follows.

In an embodiment, the following conditions need to be met when selecting a logical channel:

whether the pre-configured allowedSCS-List contains the subcarrier spacing corresponding to the grant;

whether the pre-configured maxPUSCH-Duration is greater than or equal to the transmission duration of the physical uplink shared channel (PUSCH) corresponding to the grant;

if the grant is a Type I grant free resource, whether it is supported by the pre-configuration;

whether the pre-configured allowed secondary cell combination includes the cell corresponding to the grant;

whether the list of pre-configured cell groups allowed for use includes the cell group corresponding to the protocol; and

whether the pre-configured physical layer priority includes the physical layer priority corresponding to the grant.

In an embodiment, after the priority levels of the logical channels are selected, the specific data of the logical channels is transmitted through the following process, i.e., the logical channels are reused one by one in the order of priority levels of the logical channels according to a token bucket algorithm (Bj=PRB×time) until the token is used up or the data transmission of this logical channel is completed. After this round of process, if there is still a grant, it will continue to be reused, and the token bucket algorithm will not be considered in this case.

In an embodiment, in an extended reality (XR) service, data usually consists of a plurality of QoS flows, and different QoS flows are usually assigned to handle services of different priority levels, that is, different QoS flows are configured with different information, such as different logical channel priority levels, etc. Generally, for an XR service, the logical channels thereof have a certain association relationship. For example, the frames of a video to be transmitted are divided into I frames and P frames, which are modeled and placed in different data flows (for example, in QoS Flow1 and Qos Flow 2). In this case, the two data flows need to meet the synchronization relationship, that is, it is not allowed that one data flow has been transmitted while the other data flow has no transmission opportunity. In this case, the data of the two data flows cannot arrive at the application layer at the same time, and the data packet that has arrived has to be discarded. Therefore, it is considered that a coordinated scheduling may be performed during a procedure of the logical channel prioritization (LCP) at the media access control (MAC) layer as well as when grouping packets for data.

As shown in FIG. 2, this embodiment provides a method for scheduling a logical channel, where the method is performed by a base station, and the method includes the following step.

In step 21, first indication information is sent to a terminal;

where the first indication information is used to indicate: a predetermined association relationship existing between at least two logical channels.

The terminal involved in the embodiments of the present disclosure may be, but is not limited to, a mobile phone, a wearable device, a vehicle-mounted terminal, a road side unit (RSU), a smart household terminal, an industrial sensor device and/or a medical device, etc. In some embodiments, the terminal may be a Redcap terminal or a new radio NR terminal of a predetermined version (for example, an R17 NR terminal).

The base station involved in the present disclosure may be various types of base stations, for example, a base station of a third generation mobile communication (3G) network, a base station of a fourth generation mobile communication (4G) network, a base station of a fifth generation mobile communication (5G) network, or other evolved base stations.

In an embodiment, the first indication information is sent to the terminal, where the first indication information is used to indicate: the predetermined association relationship existing between the at least two logical channels, and the at least two logical channels are used for data transmission of a predetermined type of service. Here, the predetermined type of service may be an XR service or an XR media (XRM) service, etc. In some embodiments, the predetermined type of service is not limited to the above services, but may also be a common terminal service, which is not limited herein.

In an embodiment, in response to performing a predetermined type of service, the first indication information is sent to the terminal, where the first indication information is used to indicate: the predetermined association relationship existing between the at least two logical channels, and the at least two logical channels are used for data transmission of the predetermined type of service.

In an embodiment, in response to the terminal establishing an RRC connection with the base station, the first indication information is sent to the terminal, where the first indication information is used to indicate: the predetermined association relationship existing between at least two logical channels, and the at least two logical channels are used for data transmission of the predetermined type of service.

In an embodiment, the predetermined association relationship between the at least two logical channels is determined, and the first indication information is sent to the terminal, where the first indication information is used to indicate: the predetermined association relationship existing between the at least two logical channels.

In an embodiment, the base station only needs to notify the terminal that the at least two logical channels have an association relationship. In this case, the terminal needs to try to transmit the data of the two logical channels simultaneously during logical channel reuse (LCP operation).

In an embodiment, the at least two logical channels include a primary logical channel and a secondary logical channel subordinate to the primary logical channel.

In an embodiment, the first indication information indicates the priorities of the at least two logical channels, and the priorities include a parent priority and/or a sub-priority.

In an embodiment, the predetermined association relationship is determined based on the priorities of the at least two logical channels. The first indication information is sent to the terminal, where the first indication information is used to indicate: the predetermined association relationship existing between the at least two logical channels.

Exemplarily, the predetermined association relationship existing between the at least two logical channels is an association relationship in which the logical channels have equal priorities. Alternatively, the predetermined association relationship existing between the at least two logical channels is an association relationship in which the priorities of the logical channels are not equal.

In an embodiment, the predetermined association relationship is determined based on the priorities of the at least two logical channels, where the at least two logical channels include a primary logical channel and a secondary logical channel subordinate to the primary logical channel, and the first indication information indicates the priorities of the primary logical channel and the subordinate logical channel; or, the indicated priorities of the at least two logical channels include a parent priority and/or a sub-priority. The first indication information is sent to the terminal, where the first indication information is used to indicate: the predetermined association relationship existing between the at least two logical channels.

Exemplarily, among the at least two logical channels, the priorities between the logical channels are respectively a primary-secondary relationship or a primary-subordination relationship. For example, the at least two logical channels include a logical channel 1 and a logical channel 2, the logical channel 1 is a primary logical channel, and the logical channel 2 is a secondary logical channel of the logical channel 1.

Exemplarily, for the case where the priorities of the at least two logical channels include a parent priority and/or a sub-priority, the priority of the logical channel 1 is a parent priority 1, and the priority of the logical channel 2 may be further configured with a sub-priority level based on the configuration of the parent priority 1, such as a sub-priority 1-1 or a sub-priority 1.1. In some embodiments, the sub-priority of the logical channel may be further subdivided, for example, a sub-priority 1-1-1 and a sub-priority 1-1-1-1, etc.

In an embodiment, the first indication information is sent to the terminal, where the first indication information is used to indicate: the predetermined association relationship existing between the at least two logical channels, where an indication field of the first indication information includes a logical channel attribute field of the secondary logical channel, and the logical channel attribute field indicates a primary logical channel of the secondary logical channel.

In an embodiment, the first indication information is sent to the terminal, where the first indication information is used to indicate: the predetermined association relationship existing between at least two logical channels, where the indication field of the first indication information includes a logical channel attribute field of the primary logical channel, and the logical channel attribute field indicates a secondary logical channel of the primary logical channel.

Exemplarily, the secondary logical channel, i.e., the logical channel 2, is added with a logical channel attribute identifier, for example, primary-LCH. If the primary-LCH is configured, for example, as LCH1, it indicates that the logical channel 2 is the secondary logical channel of the logical channel 1.

Exemplarily, the primary logical channel, i.e., the logical channel 1, is added a logical channel attribute identifier, for example, Secondary-LCH. If the Secondary-LCH is configured, for example, as LCH2, it indicates that the logical channel 1 is the primary logical channel of the logical channel 2.

In an embodiment, the first indication information is sent to the terminal, where the first indication information is used to indicate: the predetermined association relationship existing between the at least two logical channels, where the at least two logical channels include the primary logical channel and the secondary logical channel subordinate to the primary logical channel, and the first indication information indicates the priorities of the primary logical channel and the secondary logical channel.

In an embodiment, the first indication information is sent to the terminal, where the first indication information is used to indicate a sub-priority level attribute of the logical channel, for example, the priority includes a parent priority and/or a sub-priority; the indication field of the first indication information includes the priority attribute field of the logical channel, and the priority attribute field indicates the priorities of the logical channels.

In an embodiment, the first indication information is sent to the terminal, where the first indication information is used to indicate: the predetermined association relationship existing between the at least two logical channels. The indication field of the first indication information includes the logical channel attribute field of the secondary logical channel, and the logical channel attribute field indicates the primary logical channel of the secondary logical channel. The indication field of the first indication information includes the priority attribute field of the logical channel, and the priority attribute field indicates the priorities of the logical channels.

In an embodiment, the first indication information is sent to the terminal, where the first indication information is used to indicate: the predetermined association relationship existing between at least two logical channels. The indication field of the first indication information includes a logical channel attribute field of the primary logical channel, and the logical channel attribute field indicates the secondary logical channel of the primary logical channel. The indication field of the first indication information includes the priority attribute field of the logical channel, and the priority attribute field indicates the priorities of the logical channels.

Exemplarily, an attribute of a sub-priority is added to the logical channel 2 to configure a sub-priority for the logical channel 2; for example, the sub-priority configured for logical channel 2 is 1; however, the parent priority attribute of the logical channel 2 is the same as LCH1 in the above example.

In an embodiment, second indication information sent by a core network function is received, where the second indication information indicates: the predetermined association relationship. The predetermined association relationship is determined based on the second indication information. First indication information is sent to the terminal, where the first indication information is used to indicate: the predetermined association relationship existing between the at least two logical channels.

In an embodiment, in a process for establishing a packet data unit (PDU) session, the second indication information is received, where the second indication information indicates: the predetermined association relationship. The predetermined association relationship is determined based on the second indication information. The first indication information is sent to the terminal, where the first indication information is used to indicate: the predetermined association relationship existing between the at least two logical channels.

In an embodiment, in a process for establishing a packet data network (PDN) connection, the second indication information is received, where the second indication information indicates: the predetermined association relationship. The predetermined association relationship is determined based on the second indication information. The first indication information is sent to the terminal, where the first indication information is used to indicate: the predetermined association relationship existing between the at least two logical channels.

In an embodiment, the second indication information sent by the core network function is received, where the second indication information indicates: a subordination relationship between at least two quality of service (Qos) flows. The predetermined association relationship is determined based on the subordination relationship between the at least two quality of service (Qos) flows, where the predetermined association relationship includes a subordination relationship between the at least two logical channels. The first indication information is sent to the terminal, where the first indication information is used to indicate: the predetermined association relationship existing between the at least two logical channels.

In the embodiments of the present disclosure, first indication information is sent to a terminal, where the first indication information is used to indicate: a predetermined association relationship between at least two logical channels. Here, the base station sends the first indication information that indicates the predetermined association relationship between at least two logical channels to the terminal. After the terminal receives the first indication information, it can determine whether at least one logical channel uses the grant of the network based on the predetermined association relationship indicated by the first indication information, thereby realizing the coordinated scheduling of the logical channels, reducing the packet loss rate, and improving the scheduling efficiency.

The method provided in the embodiment of the present disclosure may be performed individually or together with some methods in some embodiments of the present disclosure or some methods in the related art.

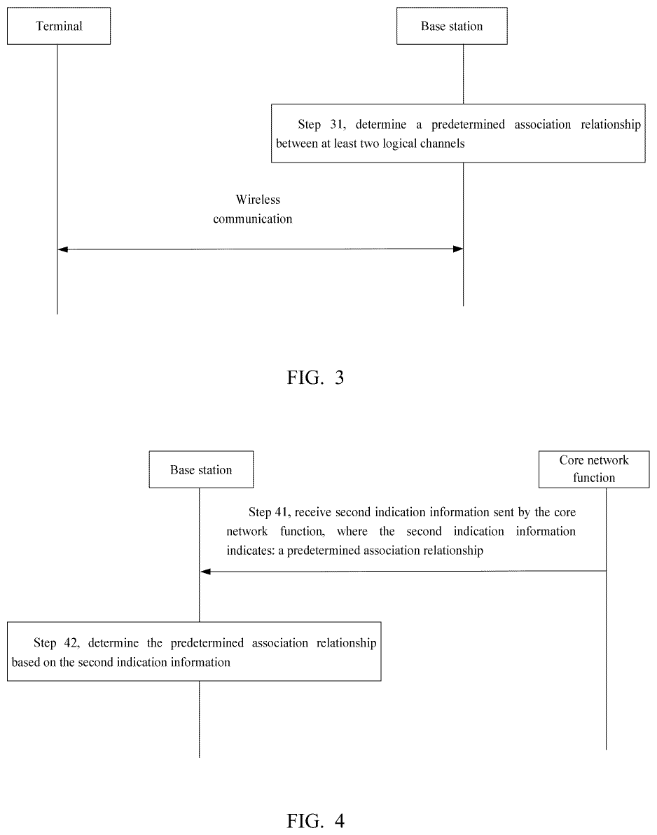

As shown in FIG. 3, this embodiment provides a method for scheduling a logical channel, where the method is performed by a base station, and the method includes the following step.

In step 31, a predetermined association relationship between at least two logical channels is determined.

In an embodiment, the predetermined association relationship between the at least two logical channels is determined, and first indication information is sent to a terminal, where the first indication information is used to indicate: the predetermined association relationship existing between the at least two logical channels.

In an embodiment, the predetermined association relationship is determined based on priorities of the at least two logical channels. The first indication information is sent to the terminal, where the first indication information is used to indicate: the predetermined association relationship existing between the at least two logical channels.

Exemplarily, the predetermined association relationship existing between the at least two logical channels is an association relationship in which the logical channels have equal priorities. Alternatively, the predetermined association relationship existing between the at least two logical channels is an association relationship in which the priorities of the logical channels are not equal.

In an embodiment, the predetermined association relationship is determined based on the priorities of the at least two logical channels, where the at least two logical channels include a primary logical channel and a secondary logical channel subordinate to the primary logical channel, and the first indication information indicates the priorities of the primary logical channel and the subordinate logical channel. The priority includes a parent priority and/or a sub-priority. The first indication information is sent to the terminal, where the first indication information is used to indicate: the predetermined association relationship existing between the at least two logical channels.

The method provided in the embodiment of the present disclosure may be performed individually or together with some methods in some embodiments of the present disclosure or some methods in the related art.

As shown in FIG. 4, this embodiment provides a method for scheduling a logical channel, where the method is performed by a base station, and the method includes the following steps.

In step 41, second indication information sent by a core network function is received, where the second indication information indicates: a predetermined association relationship.

In step 42, the predetermined association relationship is determined based on the second indication information.

In an embodiment, the second indication information sent by the core network function is received, where the second indication information indicates: the predetermined association relationship. The predetermined association relationship is determined based on the second indication information. First indication information is sent to a terminal, where the first indication information is used to indicate: a predetermined association relationship existing between at least two logical channels.

In an embodiment, the second indication information sent by the core network function is received, where the second indication information indicates: a subordination relationship between at least two quality of service (Qos) flows. The predetermined association relationship is determined based on the subordination relationship between the at least two quality of service (Qos) flows, where the predetermined association relationship includes a subordination relationship between the at least two logical channels. The first indication information is sent to the terminal, where the first indication information is used to indicate: the predetermined association relationship existing between the at least two logical channels.

The method provided in the embodiment of the present disclosure may be performed individually or together with some methods in some embodiments of the present disclosure or some methods in the related art.

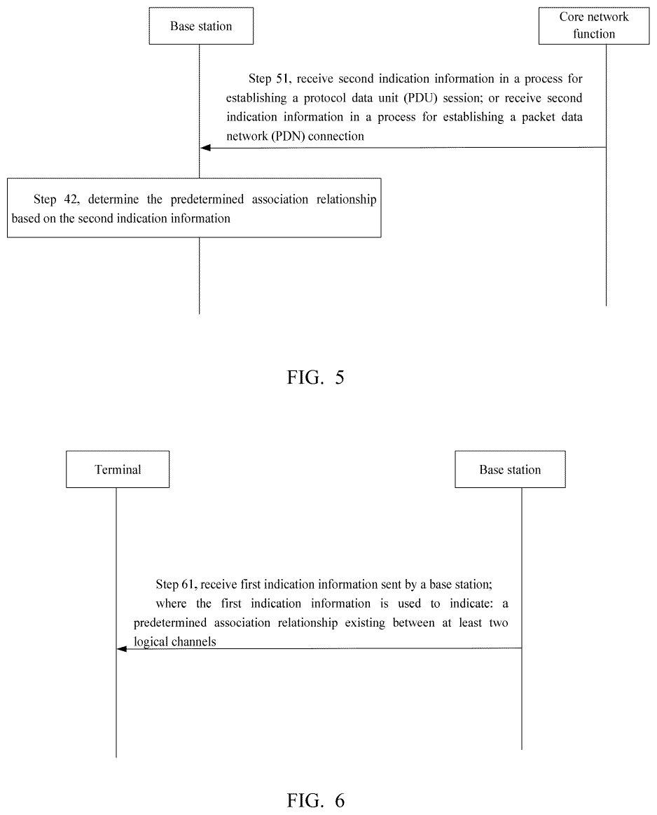

As shown in FIG. 5, this embodiment provides a method for scheduling a logical channel, where the method is performed by a base station, and the method includes the following step.

In step 51, in a process for establishing a protocol data unit (PDU) session, second indication information is received;

or,

in a process for establishing a packet data network (PDN) connection, second indication information is received.

In an embodiment, in the process for establishing the packet data unit (PDU) session, the second indication information is received, where the second indication information indicates: the predetermined association relationship. The predetermined association relationship is determined based on the second indication information. The first indication information is sent to the terminal, where the first indication information is used to indicate: the predetermined association relationship existing between the at least two logical channels.

In an embodiment, in the process for establishing a packet data network (PDN) connection, the second indication information is received, where the second indication information indicates: the predetermined association relationship. The predetermined association relationship is determined based on the second indication information. The first indication information is sent to the terminal, where the first indication information is used to indicate: the predetermined association relationship existing between the at least two logical channels.

The method provided in the embodiment of the present disclosure may be performed individually or together with some methods in some embodiments of the present disclosure or some methods in the related art.

As shown in FIG. 6, this embodiment provides a method for scheduling a logical channel, where the method is performed by a terminal, and the method includes the following step.

In step 61, first indication information sent by a base station is received;

where the first indication information is used to indicate: a predetermined association relationship existing between at least two logical channels.

The terminal involved in the embodiments of the present disclosure may be, but is not limited to, a mobile phone, a wearable device, a vehicle-mounted terminal, a road side unit (RSU), a smart household terminal, an industrial sensor device and/or a medical device, etc. In some embodiments, the terminal may be a Redcap terminal or a new radio NR terminal of a predetermined version (for example, an R17 NR terminal).

The base station involved in the present disclosure may be various types of base stations, for example, a base station of a third generation mobile communication (3G) network, a base station of a fourth generation mobile communication (4G) network, a base station of a fifth generation mobile communication (5G) network, or other evolved base stations.

In an embodiment, the first indication information sent by the base station is received, where the first indication information is used to indicate: the predetermined association relationship existing between the at least two logical channels, and the at least two logical channels are used for data transmission of a predetermined type of service. Here, the predetermined type of service may be an XR service or an XR media (XRM) service, etc. It should be noted that the predetermined type of service is not limited to the above services, but may also be a common terminal service, which is not limited herein.

In an embodiment, the first indication information sent by the base station is received, where the first indication information is used to indicate: the predetermined association relationship existing between the at least two logical channels. In this case, the terminal needs to try to transmit the data of the two logical channels simultaneously during logical channel reuse (LCP operation).

Exemplarily, the predetermined association relationship existing between the at least two logical channels is an association relationship in which the logical channels have equal priorities. Alternatively, the predetermined association relationship existing between the at least two logical channels is an association relationship in which the priorities of the logical channels are not equal.

In an embodiment, the first indication information sent by the base station is received, where the first indication information is used to indicate: the predetermined association relationship existing between the at least two logical channels. The at least two logical channels include a primary logical channel and a secondary logical channel subordinate to the primary logical channel. The first indication information indicates the priorities of the primary logical channel and the secondary logical channel, where the priorities include a parent priority and/or a sub-priority.

Exemplarily, among the at least two logical channels, the priorities between the logical channels are respectively a primary-secondary relationship or a primary-subordination relationship. For example, the at least two logical channels include a logical channel 1 and a logical channel 2, the logical channel 1 is a primary logical channel, and the logical channel 2 is a secondary logical channel of the logical channel 1. The priority of the logical channel 1 is a parent priority 1, and the priority of the logical channel 2 is a sub-priority 1-1 or a sub-priority 1.1. It should be noted that the sub-priority of the logical channel may be further subdivided, for example, a sub-priority 1-1-1 and a sub-priority 1-1-1-1, etc.

In an embodiment, the first indication information sent by the base station is received, where the first indication information is used to indicate: the predetermined association relationship existing between the at least two logical channels, where an indication field of the first indication information includes a logical channel attribute field of the secondary logical channel, and the logical channel attribute field indicates a primary logical channel of the secondary logical channel.

In an embodiment, the first indication information sent by the base station is received, where the first indication information is used to indicate: the predetermined association relationship existing between at least two logical channels, where the indication field of the first indication information includes a logical channel attribute field of the primary logical channel, and the logical channel attribute field indicates a secondary logical channel of the primary logical channel.

Exemplarily, the secondary logical channel, i.e., the logical channel 2, is added with a logical channel attribute identifier, for example, primary-LCH. If the primary-LCH is configured, for example, as LCH1, it indicates that the logical channel 2 is the secondary logical channel of the logical channel 1.

Exemplarily, the primary logical channel, i.e., the logical channel 1, is added a logical channel attribute identifier, for example, Secondary-LCH. If the Secondary-LCH is configured, for example, as LCH2, it indicates that the logical channel 1 is the primary logical channel of the logical channel 2.

In an embodiment, the first indication information sent by the base station is received, where the first indication information is used to indicate: the predetermined association relationship existing between the at least two logical channels, where the at least two logical channels include the primary logical channel and the secondary logical channel subordinate to the primary logical channel, and the first indication information indicates the priorities of the primary logical channel and the secondary logical channel, and the priorities include the parent priority and/or the sub-priority. The indication field of the first indication information includes the priority attribute field of the logical channel, and the priority attribute field indicates the priorities of the logical channels.

In an embodiment, the first indication information sent by the base station is received, where the first indication information is used to indicate: the predetermined association relationship existing between the at least two logical channels. The indication field of the first indication information includes a logical channel attribute field of the secondary logical channel, and the logical channel attribute field indicates the primary logical channel of the secondary logical channel. The indication field of the first indication information includes the priority attribute field of the logical channel, and the priority attribute field indicates the priorities of the logical channels.

In an embodiment, the first indication information sent by the base station is received, where the first indication information is used to indicate: the predetermined association relationship existing between the at least two logical channels. The indication field of the first indication information includes a logical channel attribute field of the primary logical channel, and the logical channel attribute field indicates the secondary logical channel of the primary logical channel. The indication field of the first indication information includes the priority attribute field of the logical channel, and the priority attribute field indicates the priorities of the logical channels.

Exemplarily, an attribute of a sub-priority is added to the logical channel 2 to configure a sub-priority for the logical channel 2; for example, the sub-priority configured for the logical channel 2 is 1; however, the parent priority attribute of the logical channel 2 is the same as LCH1 in the above example.

In an embodiment, the first indication information sent by the base station is received, where the first indication information is used to indicate: the predetermined association relationship existing between the at least two logical channels. During a logical channel prioritization (LCP) processing, it is determined whether the at least one logical channel uses a grant of a network according to a preset rule.

In an embodiment, the first indication information sent by the base station is received, where the first indication information is used to indicate: the predetermined association relationship existing between the at least two logical channels. Based on an LCP processing result of a single logical channel of the at least one logical channel, it is determined whether the at least one logical channel uses the grant of the network.

Exemplarily, if the first indication information indicates that a plurality of logical channels have a predetermined association relationship, a decision may be made on only the LCP process of one of the logical channels, and the result may be applied to the logical channels associated with that logical channel.

In an embodiment, the first indication information sent by the base station is received, where the first indication information is used to indicate: the predetermined association relationship existing between the at least two logical channels. The logical channels include the primary logical channel and the secondary logical channel subordinate to the primary logical channel. Based on the LCP processing result of the primary logical channel, it is determined whether the at least one logical channel uses the grant of the network.

Exemplarily, the logical channel decision is performed only for the primary logical channel with a primary-subordination relationship. For example, if the logical channel 1 and the logical channel 2 are in a primary-subordination relationship, only the primary logical channel (i.e., the logical channel 1) is selected for LCP process decision. During the process of performing LCP based on the logical channel 1, if it passes (i.e., is selected), both the logical channel 1 and the logical channel 2 pass the logical channel prioritization processing of LCP.

In an embodiment, the first indication information sent by the base station is received, where the first indication information is used to indicate: the predetermined association relationship existing between the at least two logical channels. Based on the LCP processing result of the logical channel with a priority greater than a predetermined priority, it is determined whether the at least one logical channel uses the grant of the network.

Exemplarily, one logical channel is selected from the logical channels that have the association relationship for logical channel decision. For example, if the logical channel 1 and the logical channel 2 are logical channels that have the association relationship, only one of the logical channels is selected for LCP decision. During the process of performing LCP based on the logical channel 1, if it passes (i.e. is selected), both the logical channel 1 and the logical channel 2 pass the logical channel prioritization processing of LCP. The selected logical channel may be selected arbitrarily, or, it may also be selected according to the priority.

In an embodiment, the first indication information sent by the base station is received, where the first indication information is used to indicate: the predetermined association relationship existing between the at least two logical channels. A predetermined operation is performed based on the predetermined association relationship, where the predetermined operation includes at least one of the following: using a resource allocated to the at least one logical channel, and reporting a buffer status report (BSR).

In an embodiment, the first indication information sent by the base station is received, where the first indication information is used to indicate: the predetermined association relationship between the at least two logical channels, where the logical channels include the primary logical channel and the secondary logical channel subordinate to the primary logical channel. The predetermined operation is performed based on a subordination relationship between the logical channels, where the predetermined operation includes at least one of the following: using the resource allocated to the at least one logical channel, and reporting the buffer status report (BSR).

Exemplarily, for logical channels that have an association relationship, data reuse will be sequentially reused in the order of the primary logical channel and the secondary logical channel. For example, the priority level of the logical channel 1 is 1, the logical channel 2 is a secondary logical channel of the logical channel 1, and the priority level thereof is 1.1; logical channel 3 is a secondary logical channel of the logical channel 1, and the priority level thereof is 1.2; in this case, the selection order of the logical channels is the logical channel 1, the logical channel 2, and the logical channel 3 in sequence. That is, they are first sorted according to the order of primary logical channels and then sorted according to order of the secondary logical channels.

In an embodiment, the first indication information sent by the base station is received, where the first indication information is used to indicate: the predetermined association relationship existing between the at least two logical channels, where the logical channels include the primary logical channel and the secondary logical channel subordinate to the primary logical channel. The predetermined operation is performed based on the parent priority and the sub-priority of the logical channel, where the predetermined operation includes at least one of the following: using the resource allocated to the at least one logical channel, and reporting the buffer status report (BSR).

In an embodiment, for logical channels that have an association relationship, the priority levels of logical channels of data reuse will be reused in the order of priority levels of the primary logical channels. For example, the priority level of the logical channel 1 is 1, the logical channel 2 is a secondary logical channel of the logical channel 1, and logical channel 3 is a non-associated channel with a priority level of 2. In this case, the selection order of the logical channels is the logical channel 1, the logical channel 2, and the logical channel 3 in sequence, that is, the logical channel 2 is also sorted according to the priority level of the primary logical channel.

In an embodiment, for logical channels that have an association relationship, data reuse will be performed in the order of one logical channel coming first and the other logical channels among the logical channels that have the association relationship coming later for reuse. For example, the priority level of logical channel 1 is 1, and logical channel 2 has an association relationship with the logical channel 1, and the priority thereof is 3. In this case, even if the priority of the logical channel 3 is 2, the logical channel 3 still needs to be reused after the logical channel 2. In this way, logical channels that have the association relationship can be bound for transmission and can be synchronized to reach the network side as much as possible.

When reporting the BSR, if there is data to be transmitted on a certain logical channel, it is usually necessary to consider the arrival of data with a higher logical channel priority level before reporting the BSR. In this case, the higher logical channel priority level needs to considered higher than the priority level of the data to be transmitted, including the level of the primary logical channel and the level of the secondary logical channel of the data to be transmitted.

In an embodiment, the reuse between the secondary logical channels may not be distinguished in order.

The method provided in the embodiment of the present disclosure may be performed individually or together with some methods in some embodiments of the present disclosure or some methods in the related art.

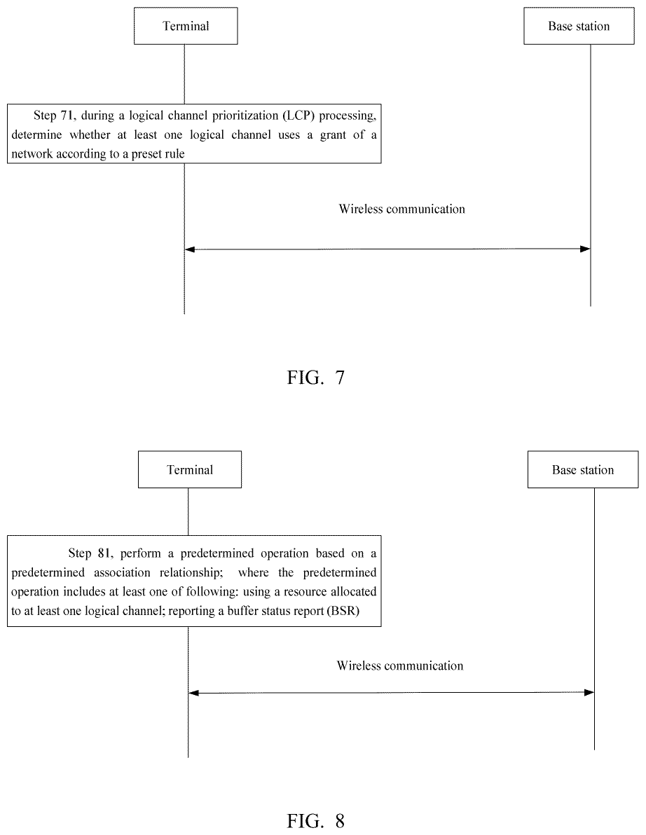

As shown in FIG. 7, this embodiment provides a method for scheduling a logical channel, where the method is performed by a terminal, and the method includes the following step.

In step 71, during a logical channel prioritization (LCP) processing, it is determined whether at least one logical channel uses a grant of a network according to a preset rule.

In an embodiment, the first indication information sent by the base station is received, where the first indication information is used to indicate: a predetermined association relationship existing between at least two logical channels. During the logical channel prioritization (LCP) processing, it is determined whether the at least one logical channel uses the grant of the network according to the preset rule.

In an embodiment, the first indication information sent by the base station is received, where the first indication information is used to indicate: the predetermined association relationship existing between the at least two logical channels. Based on an LCP processing result of a single logical channel of the at least one logical channel, it is determined whether the at least one logical channel uses the grant of the network.

Exemplarily, if the first indication information indicates that a plurality of logical channels have a predetermined association relationship, a decision may be made on only the LCP process of one of the logical channels, and the result may be applied to the logical channels associated with that logical channel.

In an embodiment, the first indication information sent by the base station is received, where the first indication information is used to indicate: the predetermined association relationship existing between the at least two logical channels. The logical channels include a primary logical channel and a secondary logical channel subordinate to the primary logical channel. Based on the LCP processing result of the primary logical channel, it is determined whether the at least one logical channel uses the grant of the network.

Exemplarily, the logical channel decision is performed only for the primary logical channel with a primary-subordination relationship. For example, if the logical channel 1 and the logical channel 2 are in a primary-subordination relationship, only the primary logical channel (i.e., the logical channel 1) is selected for LCP process decision. During the process of performing LCP based on logical channel 1, if the logical channel 1 passes (i.e., is selected), both the logical channel 1 and the logical channel 2 pass the logical channel prioritization processing of LCP.

In an embodiment, the first indication information sent by the base station is received, where the first indication information is used to indicate: the predetermined association relationship existing between the at least two logical channels. Based on the LCP processing result of the logical channel with a priority greater than a predetermined priority, it is determined whether the at least one logical channel uses the grant of the network.

Exemplarily, one logical channel is selected from the logical channels that have the association relationship for logical channel decision. For example, if the logical channel 1 and the logical channel 2 are logical channels that have the association relationship, only one of the logical channels is selected for LCP decision. During the process of performing LCP based on logical channel 1, if the logical channel 1 passes (i.e. is selected), both logical channel 1 and logical channel 2 pass the logical channel prioritization processing of LCP. The selected logical channel may be selected arbitrarily, or, it may also be selected according to the priority.

The method provided in the embodiment of the present disclosure may be performed individually or together with some methods in some embodiments of the present disclosure or some methods in the related art.

As shown in FIG. 8, this embodiment provides a method for scheduling a logical channel, where the method is performed by a terminal, and the method includes the following step.

In step 81, a predetermined operation is performed based on a predetermined association relationship;

where the predetermined operation includes at least one of following:

using a resource allocated to at least one logical channel; and

reporting a buffer status report (BSR).

In an embodiment, the first indication information sent by the base station is received, where the first indication information is used to indicate: the predetermined association relationship existing between at least two logical channels. The predetermined operation is performed based on the predetermined association relationship, where the predetermined operation includes at least one of the following: using the resource allocated to the at least one logical channel, and reporting the buffer status report (BSR).

In an embodiment, the first indication information sent by the base station is received, where the first indication information is used to indicate: the predetermined association relationship between the at least two logical channels, where the logical channels include a primary logical channel and a secondary logical channel subordinate to the primary logical channel. The predetermined operation is performed based on a subordination relationship between the logical channels, where the predetermined operation includes at least one of the following: using the resource allocated to the at least one logical channel, and reporting the buffer status report (BSR).

Exemplarily, for logical channels that have an association relationship, data reuse will be sequentially reused in the order of the primary logical channel and the secondary logical channel. For example, the priority level of logical channel 1 is 1, logical channel 2 is a secondary logical channel of the logical channel 1, and the priority level thereof is 1.1; logical channel 3 is a secondary logical channel of the logical channel 1, and the priority level thereof is 1.2; in this case, the selection order of the logical channels is the logical channel 1, the logical channel 2, and the logical channel 3 in sequence. That is, the logical channels are first sorted according to the order of primary logical channels and then sorted according to order of the secondary logical channels.

In an embodiment, the first indication information sent by the base station is received, where the first indication information is used to indicate: the predetermined association relationship existing between the at least two logical channels, where the logical channels include the primary logical channel and the secondary logical channel subordinate to the primary logical channel. The predetermined operation is performed based on the parent priority and the sub-priority of the logical channel, where the predetermined operation includes at least one of the following: using the resource allocated to the at least one logical channel, and reporting the buffer status report (BSR).

In an embodiment, for logical channels that have an association relationship, the priority levels of logical channels of data multiplexing will be multiplexed in the order of priority levels of the primary logical channels. For example, the priority level of logical channel 1 is 1, logical channel 2 is a secondary logical channel of the logical channel 1, and logical channel 3 is a non-associated channel with a priority level of 2. In this case, the selection order of the logical channels is logical channel 1, logical channel 2, and logical channel 3 in sequence, that is, the logical channel 2 is also sorted according to the priority level of the primary logical channel.

In an embodiment, for logical channels that have an association relationship, data multiplexing will be performed in the order of one logical channel coming first and the other logical channels among the logical channels that have the association relationship coming later. For example, the priority of logical channel 1 is 1, and logical channel 2 has an association relationship with the logical channel 1, and the priority thereof is 3. In this case, even if the priority of logical channel 3 is 2, it still needs to be multiplexed after the logical channel 2.

In some embodiments, the reuse between the secondary logical channels may not be distinguished in order.

The method provided in the embodiment of the present disclosure may be performed individually or together with some methods in some embodiments of the present disclosure or some methods in the related art.

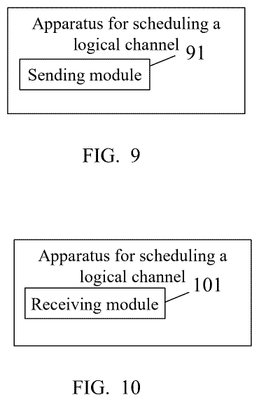

As shown in FIG. 9, this embodiment provides an apparatus for scheduling a logical channel, where the apparatus includes:

a sending module 91, configured to send first indication information to a terminal;

where the first indication information is used to indicate: a predetermined association relationship existing between at least two logical channels.

The method provided in the embodiment of the present disclosure may be performed individually or together with some methods in some embodiments of the present disclosure or some methods in the related art.

As shown in FIG. 10, this embodiment provides an apparatus for scheduling a logical channel, where the apparatus includes:

a receiving module 101, configured to receive first indication information sent by a base station;

where the first indication information is used to indicate: a predetermined association relationship existing between at least two logical channels.

The method provided in the embodiment of the present disclosure may be performed individually or together with some methods in some embodiments of the present disclosure or some methods in the related art.

An embodiment of the present disclosure provides a system for scheduling a logical channel, where the system includes a terminal and a base station; the terminal executes any of the methods executed by the terminal as described in the embodiments of the present disclosure, and the base station executes any of the methods executed by the base station as described in the embodiments of the present disclosure.

An embodiment of the present disclosure provides a communication device, where the communication device includes:

a processor;

a memory for storing instructions executable by the processor;

where the processor is configured to implement the method applied to any embodiment of the present disclosure when running the executable instructions.

The processor may include various types of storage mediums, which are non-transitory computer storage mediums capable of continuing to memorize and store information stored thereon after the communication device is powered down.

The processor may be connected to the memory via a bus or the like for reading an executable program stored in the memory.

An embodiment of the present disclosure further provides a computer storage medium, where the computer storage medium stores a computer executable program, and the executable program implements the method of any embodiment of the present disclosure when being executed by a processor.

Regarding the apparatuses in the above embodiments, the specific manner in which each module thereof performs operations has been described in detail in the embodiments regarding the methods, and will not be described in detail herein.

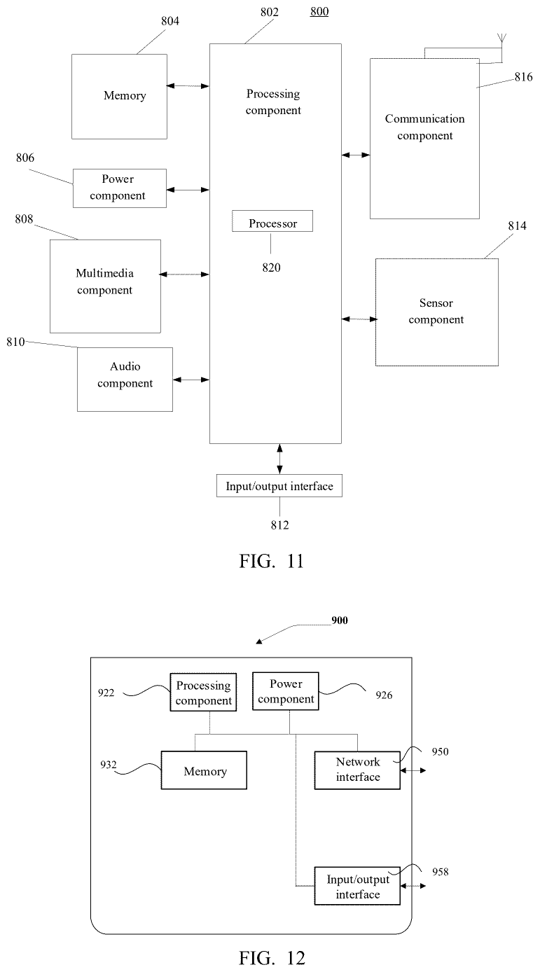

As shown in FIG. 11, an embodiment of the present disclosure provides a structure of a terminal.

Referring to the terminal 800 as shown in FIG. 11, the present embodiment provides a terminal 800, which may specifically be a mobile phone, a computer, a digital broadcast terminal device, a messaging device, a gaming console, a tablet, a medical device, an exercise equipment, a personal digital assistant, and the like.

Referring to FIG. 11, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operation of the terminal 800, such as the operations associated with display, telephone calls, data communications, camera operations, and recording operations. The processing component 802 may include one or more processors 820 to execute instructions to complete all or part of the steps of the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal 800. Examples of such data include instructions for any applications or methods operated on the terminal 800, contact data, phonebook data, messages, pictures, videos, etc. The memory 804 may be implemented using any type of volatile or non-volatile memory devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 806 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 808 includes a front camera and/or a rear camera. The front camera and/or the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 800. For instance, the sensor component 814 may detect an open/closed status of the device 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate communication, wired or wirelessly, between the terminal 800 and other devices. The terminal 800 can access a wireless network based on a communication standard, such as WiFi, 2G or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the terminal 800, for completing the above methods. For example, the non-transitory computer-readable storage medium may be a ROM, a random access memory (RAM), a CD-ROM, a magnetic tape, a floppy disc, an optical data storage device, and the like.

As shown in FIG. 12, an embodiment of the present disclosure illustrates a structure of a base station. For example, the base station 900 may be provided as a net-work side device. Referring to FIG. 12, the base station 900 includes a processing component 922, which further includes one or more processor, and a memory resource represented by a memory 932 for storing instructions, such as an application program, that may be executed by the processing component 922. The application program stored in the memory 932 may include one or more modules, each corresponding to a set of instructions. In addition, the processing component 922 is configured to execute instructions to perform any of the aforementioned methods applied to the base station.

The base station 900 may further include a power component 926 configured to perform power management of the base station 900, a wired or wireless network interface 950 configured to connect the base station 900 to the network, and an input/output (I/O) interface 958. The base station 900 may operate based on an operating system stored in the memory 932, such as a Windows Server™, a Mac OS X™, a Unix™, a Linux™, a Free BSD™ or the like.

The present disclosure is intended to cover any variations, uses or adaptations of the present disclosure that follow the general principles of the present disclosure and include common knowledge or customary techniques in the art that are not disclosed in the present disclosure. The specification and the embodiments are considered exemplary only, and the true scope and spirit of the present disclosure are indicated by the following claims.

It should be understood that the present disclosure is not limited to the exact structures that have been described above and shown in the accompanying drawings, and various modifications and changes may be made without departing from the scope thereof. The scope of the present disclosure is limited only by the appended claims.

1. A method for scheduling a logical channel, comprising:
sending, by a base station, first indication information to a terminal;
wherein the first indication information is used to indicate: a predetermined association relationship existing between at least two logical channels.

2. The method according to claim 1, wherein the at least two logical channels are used for data transmission of a predetermined type of service.

3. The method according to claim 1, further comprising:
determining, by the base station, the predetermined association relationship between the at least two logical channels.

4. The method according to claim 3, wherein determining the predetermined association relationship between the at least two logical channels comprises:
determining the predetermined association relationship based on priorities of the at least two logical channels.

5. The method according to claim 4, wherein the at least two logical channels comprise a primary logical channel and a secondary logical channel subordinate to the primary logical channel, and
an indication field of the first indication information comprises at least one of a logical channel attribute field or a priority attribute field of a logical channel, the logical channel attribute field indicates at least one of the primary logical channel of the secondary logical channel or the secondary logical channel of the primary logical channel, and the priority attribute field indicates the priorities of the at least two logical channels.

6. The method according to claim 4, wherein the first indication information indicates the priorities of the at least two logical channels, and the priorities comprise at least one of a parent priority or a sub-priority.

7-8. (canceled)

9. The method according to claim 3, further comprising:
receiving, by the base station, second indication information sent by a core network function, wherein the second indication information indicates: the predetermined association relationship;
wherein determining the predetermined association relationship between the at least two logical channels comprises:
determining the predetermined association relationship based on the second indication information.

10. The method according to claim 9, wherein the second indication information indicates a subordination relationship between at least two quality of service (QoS) flows, and determining the predetermined association relationship based on the second indication information comprises:
determining the predetermined association relationship based on the subordination relationship between the at least two Qos flows, wherein the predetermined association relationship comprises a subordination relationship between the at least two logical channels.

11. A method for scheduling a logical channel, comprising:
receiving, by a terminal, first indication information sent by a base station;
wherein the first indication information is used to indicate: a predetermined association relationship existing between at least two logical channels.

12. The method according to claim 11, wherein the at least two logical channels are used for data transmission of a predetermined type of service, or
the first indication information indicates priorities of the at least two logical channels, and the priorities comprise at least one of a parent priority or a sub-priority.

13. The method according to claim 11, wherein the at least two logical channels comprise a primary logical channel and a secondary logical channel subordinate to the primary logical channel, and
an indication field of the first indication information comprises at least one of a logical channel attribute field or a priority attribute field of a logical channel, the logical channel attribute field indicates at least one of the primary logical channel of the secondary logical channel or the secondary logical channel of the primary logical channel, and the priority attribute field indicates priorities of the at least two logical channels.

14-16. (canceled)

17. The method according to claim 11, further comprising:
during a logical channel prioritization (LCP) processing, determining, by the terminal, whether at least one logical channel uses a grant of a network according to a preset rule.

18. The method according to claim 17, wherein determining whether the at least one logical channel uses the grant of the network according to the preset rule comprises:
determining whether the at least one logical channel uses the grant of the network based on an LCP processing result of a single logical channel of the at least one logical channel.

19. The method according to claim 18, wherein the at least two logical channels comprise a primary logical channel and a secondary logical channel subordinate to the primary logical channel, and
determining whether the at least one logical channel uses the grant of the network based on the LCP processing result of the single logical channel of the at least one logical channel comprises:
determining whether the at least one logical channel uses the grant of the network based on the LCP processing result of the primary logical channel.

20. The method according to claim 18, wherein determining whether the at least one logical channel uses the grant of the network based on the LCP processing result of the single logical channel of the at least one logical channel comprises:
determining whether the at least one logical channel uses the grant of the network based on the LCP processing result of the logical channel with a priority greater than a predetermined priority.

21. The method according to claim 11, further comprising:
performing a predetermined operation based on the predetermined association relationship;
wherein the predetermined operation comprises at least one of following:
using a resource allocated to the at least one logical channel of the at least two logical channels; or
reporting a buffer status report (BSR).

22. The method according to claim 21, wherein the at least two logical channels comprise a primary logical channel and a secondary logical channel subordinate to the primary logical channel; and
performing the predetermined operation based on the association relationship comprises:
performing the predetermined operation based on a subordination relationship between the at least two logical channels.

23. The method according to claim 21, wherein performing the predetermined operation based on the association relationship comprises:
performing the predetermined operation based on priorities of the at least two logical channels.

24. The method according to claim 23, wherein performing the predetermined operation based on the priorities of the at least two logical channels comprises:
performing the predetermined operation based on a parent priority and a sub-priority of the at least two logical channels.

25-27. (canceled)

28. An apparatus for scheduling a logical channel, comprising:
a memory; and
a processor, connected to the memory, wherein the processor is configured to execute computer executable instructions stored in the memory and is capable of implementing the following steps:
sending first indication information to a terminal;
wherein the first indication information is used to indicate: a predetermined association relationship existing between at least two logical channels.

29. (canceled)
